(19) United States
(12) Patent Application Publication
(10) Pub. No.: US 2018/0244554 A1
(43) Pub. Date: Aug. 30, 2018

(54) BATCH INLET SPOOL

(71) Applicant: OCV Intellectual Capital, LLC, Toledo, OH (US)

(72) Inventors: Steven James Mighton, Granville, OH (US); James Alan MacPhee, Newark, OH (US); Douglas Cecil Clark, Newark, OH (US)

(21) Appl. No.: 15/754,039

(22) PCT Filed: Aug. 25, 2016
(86) PCT No.: PCT/US2016/048521

§ 371 Date: Feb. 21, 2018

Related U.S. Application Data
(60) Provisional application No. 62/212,091, filed on Aug. 31, 2015.

(51) Int. Cl. C03B 3/00; C03B 5/235

(52) U.S. Cl. CPC C03B 3/00; C03B 5/2356

(57) ABSTRACT

An inlet spool for controlling the back flow of molten glass from a submerged combustion melter. The inlet spool includes a pipe having a first end, a second end, and an inner wall defining a passageway between the first end and the second end. A cross-sectional area of the passageway increases along a length of the passageway from the first end to the second end toward the melter. The passageway may be conical-shaped.

### RELATED APPLICATIONS

This application claims priority to and all benefit of U.S. Provisional Patent Application Ser. No. 62/212,091, filed on Aug. 31, 2015 and titled BATCH INLET SPOOL, the entire disclosure of which is fully incorporated herein by reference.

### BACKGROUND

In the manufacture of continuous glass filaments, a raw materials mixture is loaded into a melter to create a glass composition. The raw materials mixture used to make glass is sometimes referred to as batch. The batch is melted in a furnace, and the glass flows through a refining process to one or more bushings in a filament forming apparatus. Typically, each bushing includes many orifices or nozzles/tips through which streams of molten glass flow. The quenched glass streams are mechanically pulled from the nozzles by a winding apparatus to form continuous glass filaments.

Regarding the melter portion of this process, a conventional melter is constructed as a large single tank. The environment within the melter is maintained to be relatively calm, especially during a controlled start-up. The melter takes a relatively long time to set-up and then bring to an operating temperature. For example, the melt and refine process time in a single large refractory tank can take up to 24 hours. For operation efficiency, the cycle of each type of glass composition is relatively long. Any undesired or unexpected stoppage in the process can be extremely expensive, as large amounts of glass material may be wasted. Further, an unexpected stoppage can also be dangerous.

Various new melter designs have been developed to overcome the negative qualities of a conventional melter. One type of new design is a submerged combustion melter. The heat sources for this type of melter are positioned within and at the bottom of the furnace, that is to say, in a submerged position below the pool of molten glass. In this submerged position, the environment within the melter is much more intense and violent than a conventional melter. The time to bring the melter to an operating temperature is much shorter than a conventional melter. For example, the melt and refine process time in a submerged combustion melter may be less than 4 hours.

One advantage of the submerged combustion melter is the ability of the operator to start and stop the melting process as needed. As such, the glass composition can be changed more readily, and the operator can respond to unexpected problems downstream in a much more prompt and inexpensive manner.

### SUMMARY

The present application describes various exemplary methods and apparatus for supplying batch into the melter. The invention is directed to an inlet spool for feeding a glass batch into a melter. The spool may operate without moving parts and with static valve geometry.

In an exemplary embodiment, an inlet spool includes a pipe having a first end, a second end, and an inner wall defining a passageway between the first end and the second end. A cross-sectional area of the passageway increases along a length of the passageway from the first end to the second end and in the direction of a predetermined batch flow path. The passageway may be conical-shaped.

In another exemplary embodiment, an inlet spool includes a pipe having a first end, a second end, and an inner wall defining a conical-shaped passageway between the first end and the second end. A conical-shaped passageway increases in diameter along a length of the passageway from the first end to the second end and in the direction of a predetermined batch flow path. The inlet spool further includes a barrel having a first end and a second end, a first connector secured to the first end of the barrel, and a second connector secured to the second end of the barrel. The pipe is secured inside the barrel, and the pipe and the barrel are positioned to define a radial passageway between the pipe and the barrel.

### BRIEF DESCRIPTION OF THE DRAWINGS

Features and advantages of the general inventive concepts will become apparent from the following detailed description made with reference to the accompanying drawings.

FIG. 1a is a front sectional view of a portion of a glass production line, showing a submerged combustion melter;

FIG. 1b is a front sectional view of an enlarged portion of the submerged combustion melter of FIG. 1a;

FIG. 2a is a sectional view of an inlet spool according to the invention, showing an exemplary embodiment along the longitudinal axis;

FIG. 2b is a sectional view of an inlet spool according to the invention, showing another exemplary embodiment along the longitudinal axis;

FIG. 3 is a sectional view of the inlet spool of FIG. 2b, shown along line 3-3 of FIG. 2b; and

FIG. 4 is an enlarged view of the top portion of the inlet spool of FIG. 2b, showing a thermocouple installed.

### DETAILED DESCRIPTION

This Detailed Description merely describes exemplary embodiments in accordance with the general inventive concepts and is not intended to limit the scope of the invention in any way. Indeed, the invention as described by the claims is broader than, and unlimited by, the exemplary embodiments set forth herein, and the terms used herein have their full ordinary meaning.

The general inventive concepts will now be described with occasional reference to the various exemplary embodiments of the invention presented herein. These general inventive concepts may, however, be embodied in different forms and should not be construed as limited to the embodiments set forth herein. Rather, these embodiments are provided so that this disclosure will be thorough and complete and will fully convey the scope of the general inventive concepts to those skilled in the art.

Unless otherwise defined, all technical and scientific terms used herein have the same meaning as commonly understood by one of ordinary skill in the art encompassing the general inventive concepts. The terminology set forth in this detailed description is for describing particular embodiments only and is not intended to be limiting of the general inventive concepts. As used in this detailed description and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about,” so as to at least encompass all functionally equivalent values. Accordingly, unless otherwise indicated, the numerical properties set forth in the specification and claims are approximations that may vary depending on the suitable properties sought to be obtained in embodiments of the present invention. Notwithstanding that the numerical ranges and parameters setting forth the broad scope of the general inventive concepts are approximations, the numerical values set forth in the specific examples are reported as precisely as possible. Any numerical values, however, inherently contain certain errors necessarily resulting from error found in their respective measurements.

The present application describes various exemplary methods and apparatus for melting batch into glass. The invention is directed to an inlet spool for feeding a glass batch into a melter at an elevation lower than the glass line (surface of the molten bath). This configuration offers the benefit of reducing carry over or loss of batch if the batch were introduced above the glass line and allowed to fall down onto the surface of the molten batch due to up currents of combustion gases leaving the melter by an exhaust flue. Often, melter shut down is required for maintenance of the melter, to change the batch extruder, or to otherwise switch glass types. The hydrostatic pressure in the melter built up from the depth of molten glass exerts a force that attempts to push the molten glass out of the inlet spool in the direction of the batch supply when the batch feeder is disconnected for replacement/maintenance. The inlet spool operates to allow batch to pass toward the melter in a predetermined direction, and when the batch extruder is disconnected from the inlet spool for extruder maintenance, the spool prohibits molten glass from moving in the opposite direction through the inlet spool. In filling the melter, the batch passes in the predetermined direction through the inlet spool with a constantly increasing cross-sectional area. This geometry prohibits the potential for bridging across the face of the spool by presenting the glass flow with a negative conical taper. In other words, the negative conical taper maintains batch flow in the direction of the melter. In contrast, the constantly decreasing cross-sectional area presented to batch being pushed backwards by the hydrostatic pressure of the molten glass acts to bridge the batch in the spool which prohibits the flow of molten glass in the direction away from the melter and towards the open end of the inlet spool.

In an exemplary embodiment, an inlet spool includes a pipe having a first end, a second end, and an inner wall defining a passageway between the first end and the second end. A cross-sectional area of the passageway increases along a length of the passageway from the first end to the second end and in the direction of a predetermined glass flow path.

In another exemplary embodiment, an inner circumference of the inner wall of the pipe may increase along a length of the passageway from the first end to the second end. More specifically, a diameter of the passageway may increase along a length of the passageway from the first end to the second end. The passageway may be conical-shaped.

In another exemplary embodiment, an inlet spool includes a pipe having a first end, a second end, and an inner wall defining a passageway between the first end and the second end. A cross-sectional area of the passageway increases along a length of the passageway from the first end to the second end and in the direction of a predetermined glass flow path. The inlet spool also includes a barrel having a first end and a second end, a first connector secured to the first end of the barrel, and a second connector secured to the second end of the barrel. The pipe is secured inside the barrel. The pipe and the barrel are positioned to define a radial passageway between the pipe and the barrel. The barrel may include a coupling positioned through an external wall of the barrel to provide fluid access to the passageway. A thermocouple may be positioned for temperature readings of the contents of the passageway.

The present invention is directed to an inlet spool which is positionable in a glass processing line. The inventive inlet spool is shaped and arranged for placement downstream from a batch feeding line and upstream from a submerged combustion melter. The batch feeding line could provide a dry batch from a hopper or glass from a batch extruder. The inlet spool acts as a valve to control glass flow between the batch line and the entrance wall of a submerged combustion melter. The inlet spool may be removably connectable to the inlet batch line and the entrance wall of a submerged combustion melter by any conventional means, such as for example, by a threaded connection and a sealable flange. The feed line to the melter connects to the melter wall at a position below the predetermined glass line, that is to say, below the operational level of the molten glass.

At least one advantage of the present invention over the prior art is the inlet spool prohibits the bridging of an open line in the direction of the melter. The constantly increasing cross-sectional area of the inlet spool presents a negative slope to the glass batch in the flow direction. The inlet spool acting with static valve geometry acts to maintain operational flow in the line.

Another advantage of the present invention over the prior art is the inlet spool prohibits the backflow of molten glass on an open line disconnected from the batch source. When an operational cycle is stopped, for example, for maintenance, the inlet spool may be disconnected from the batch line. The constantly decreasing cross-sectional area of the inlet spool presents a positive slope to the glass batch in the back pressure direction. The inlet spool acting with static valve geometry acts to prohibit undesired flow completely through the inlet valve in the direction of the melter. The inlet spool has no moving parts. This feature is true during flow of liquid in either direction along a longitudinal axis of the inlet spool. However, the inlet spool acts as a valve, in so much as the inlet spool acts to allow flow in one direction, toward the melter, and prohibit flow in an opposite direction, away from the melter.

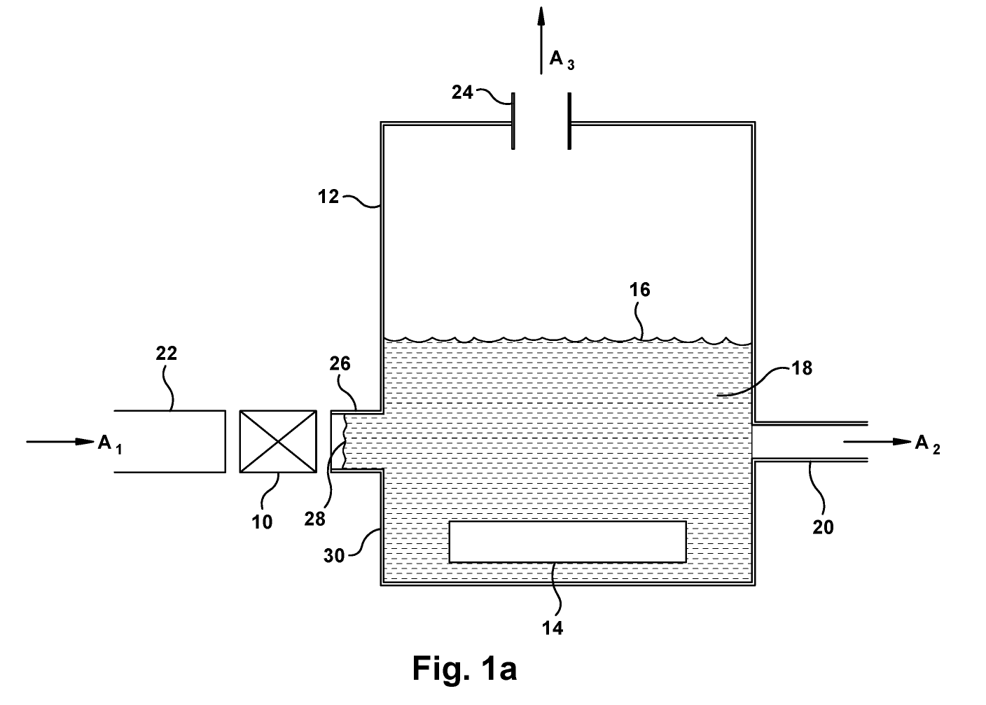

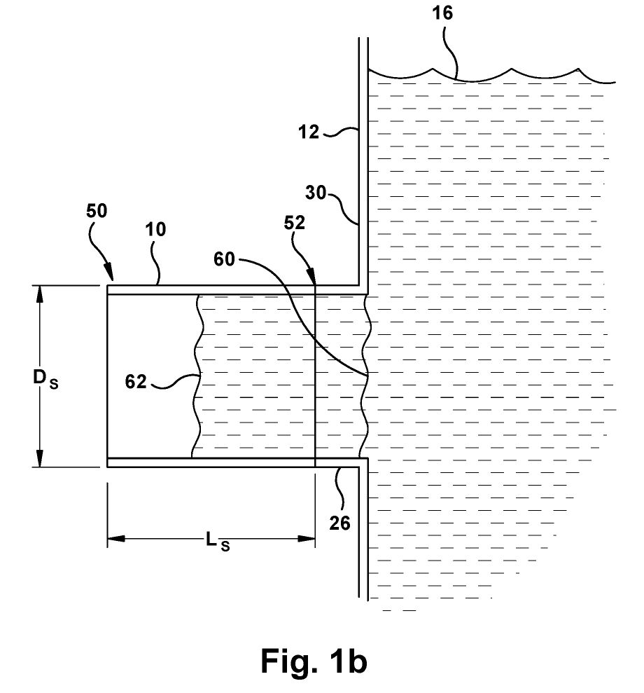

Referring now to the drawings, a portion of the glass production line is shown in FIG. 1a. The illustrated melter 12 is a submerged combustion style melter. In this style melter, the heat source, such as for example, a burner 14, is positioned within the molten glass 18 and below the top surface 16 of the molten glass. The melter 12 is supplied by a batch feeding line 22 with unmelted batch traveling in the direction A₁ from a batch source, such as for example, a dry batch from a hopper or glass from a batch extruder. The glass travels through an inlet spool 10 and into the melter 12. As illustrated, the inlet spool 10 is connected to a coupling 26 which extends from a sidewall 30 of the melter. It should be apparent to one with ordinary skill in the art that the arrangement of the inlet spool and the submerged combustion melter may vary in the practice of this invention. For example, the inlet spool may attach directly to the sidewall 30 of the melter 12.

Glass is brought to a molten condition inside the melter. Molten glass flows out of the melter 12 in the direction A₂ via an exit pipe 20 and downstream to a refining apparatus (not shown). As the melting process is on-going, exhaust gases may escape through an exit pipe 24 in the direction A₃. The invention will be discussed in view of a submerged combustion melter 12 illustrated in FIG. 1a, but it should be apparent to one with ordinary skill in the art that submerged combustion melters having other structures and/or configurations can be used in the practice of this invention.

During a melting operation cycle, the conditions within the melter 12 are maintained relatively constant, such as for example, the volume and the pressure of the molten glass. When the cycle has ended, such as at the end of a production run, for scheduled maintenance, or for an unplanned reason, the batch feeding line 22 may be disconnected from the inlet spool 10. As discussed herein, the back pressure within the melter 12 tends to cause the molten glass to be pushed out of the melter in the direction of the inlet spool 10. A front surface 28, which illustrates the movement of the molten glass in the direction of the inlet spool 10, is illustrated in FIG. 1a. This distance of movement is also discussed herein with regard to FIG. 1b.

Referring now to FIG. 1b, the inlet spool 10 and melter 12 are illustrated in a disconnected position from the batch feeding line 22. More specifically, a sectional view of an enlarged portion of the submerged combustion melter 12 of FIG. 1a is shown. The inlet spool 10 is secured to the coupling 26 which extends from the sidewall 30 of the melter 12. The inlet spool 10 has an external length L_{S} and an external diameter D_{S}, each of which are generally constant along any point of the inlet spool. For the purposes of discussion, the inlet spool 10 has a first end 50 which connects to the batch feeding line 22 (not shown in FIG. 1b) and a second end 52 which connects, directly or indirectly, to the melter 12.

The inlet spool 10 is for use in controlling glass flow. The inlet spool may be a single piece pipe, or it may be an apparatus which includes a pipe. The pipe may be a tube constructed of a wear resistant material, such as for example, carbon steel. The piece of carbon steel will be sized in accordance with the melter size in order to operate with static valve geometry. An exemplary piece of carbon steel may be machined from 10.50 inch OD and 0.50 inch wall pipe. In FIG. 1b, the pipe 10 has a first end 50 and a second end 52. An inner wall (not shown) defines a passageway between the first end and the second end.

The surface of the molten glass is an important feature of this invention. FIG. 1b illustrates two example surface positions. First position 60 illustrates the molten glass in or near the melter 12 at the time the melter is shut down and the inlet spool 10 is disconnected from the batch feeding line 22 at the first end 50 of the inlet spool 10. The molten glass is affected by the back pressure in the melter 12 and is forced in a backward direction toward the inlet spool 10. Second position 62 illustrates the molten glass after it has moved into the inlet spool 10 (i.e., beyond the sidewall 30). Without moving parts, the geometry of the inlet spool will prohibit the molten glass from advancing completely through the inlet spool 10 by the decreasing cross-sectional area in the direction from the melter. As discussed here, the tendency of the molten glass to bridge, or harden, is increased, and additional flow in that direction is prohibited.

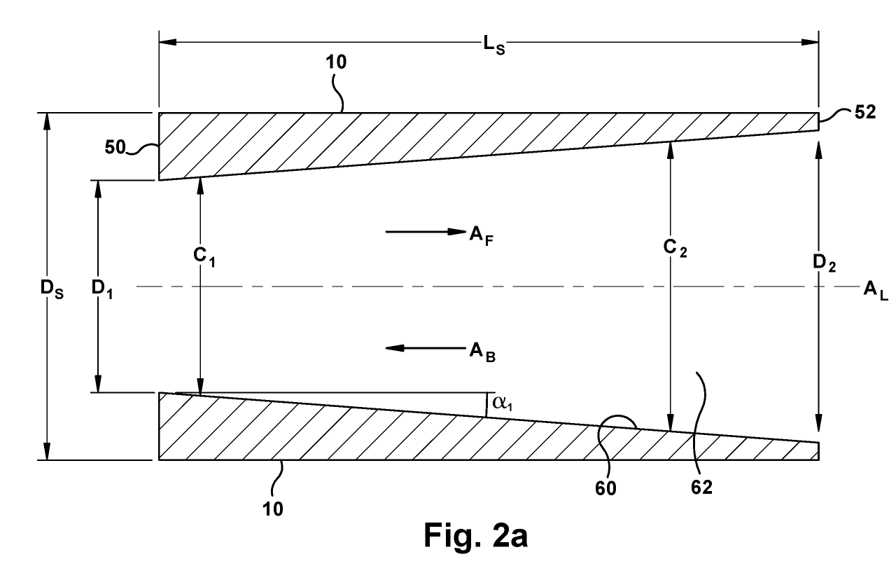

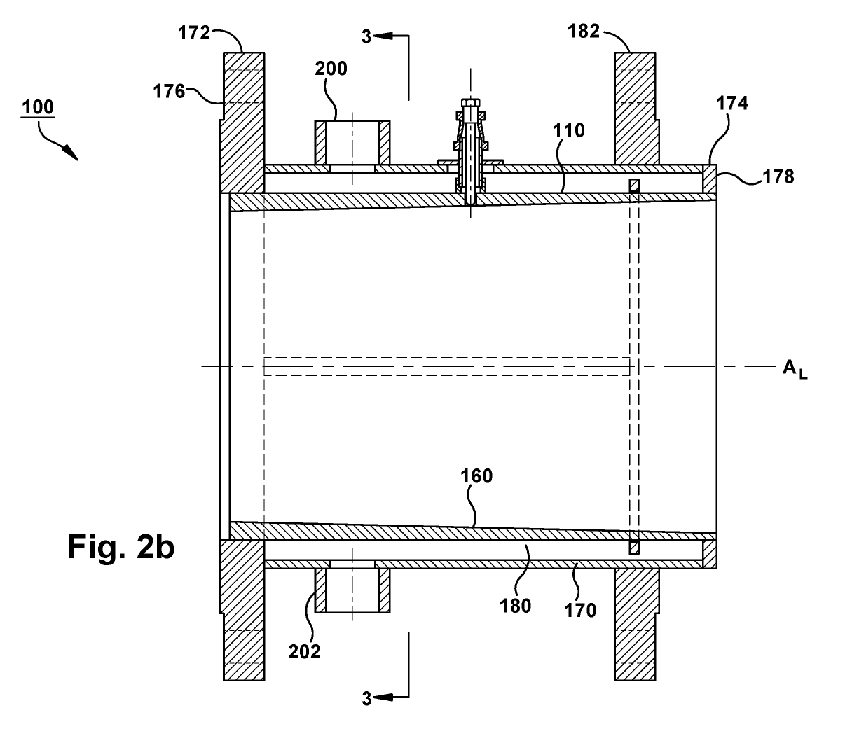

The structure of the pipe will now be discussed in greater detail. A cross-sectional view of the inlet spool 10 is shown in FIG. 2a. This figure shows the passageway 62 which is defined by an inside wall 60. The passageway 62 extends through the entire inlet spool 10, that is to say, from the first end 50 to the second end 52. The inner wall defines a cross-sectional area which increases from the first end 50 to the second end 52. In some shapes, such as a conical-shaped passageway, an inner circumference of the inner wall also increases along a length of the passageway from the first end 50 to the second end 52.

The passageway 62 may have a properly selected length to coordinate with the size of the melter. For example, the passageway may have a length between 12.25 and 17.75 inches. More specifically, the passageway may have a length between 14.00 and 16.00 inches. It should be understood to one with ordinary skill in the art that inlet spools having varied passageway lengths than those disclosed can be used in the practice of this invention.

The inner diameter of the inlet spool 10 at the first end 50 and at the second end 52 may vary. For example, the first end 50 has a first inner diameter between 9.00 and 10.00 inches. In another exemplary embodiment, the first end 50 has a first inner diameter between 9.25 and 9.75 inches. In another exemplary embodiment, the first end 50 has a first inner diameter between 9.45 and 9.55 inches. As discussed, it will be understood by one with ordinary skill in the art that the differences in the physical dimension of the first inner diameter may vary in the practice of the invention.

As discussed, the second end 52 has a second inner diameter which is larger than the first inner diameter. For example, the second end 52 has a second inner diameter between 9.25 and 10.25 inches. In another exemplary embodiment, the second end 52 has a second inner diameter between 9.50 and 10.00 inches. In another exemplary embodiment, the second end 52 has a second inner diameter between 9.70 and 9.80 inches. As discussed, it will be understood by one with ordinary skill in the art that the differences in the physical dimension of the second inner diameter may vary in the practice of the invention.

The passageway increases in size from the first end 50 to the second end 52. Upon examination, one skilled in the art will note the passageway 62 defines a ratio between the size of the first inner diameter of the first end 50 and the size of the second inner diameter of the second end 52. As discussed herein, when the passageway of the inlet spool 10 is conical-shaped, the ratio between the first end 50 and the second end 52 is controlled by the slope angle of the passageway. An exemplary embodiment for the ratio is 9 to 10, or in other words, the first inner diameter is at least 90% of the second inner diameter. In another exemplary embodiment, the ratio is 9.5 to 10, or in other words, the first inner diameter is at least 95% of the second inner diameter. In another exemplary embodiment, the ratio is 9.7 to 10, or in other words, the first inner diameter is at least 97% of the second inner diameter. As discussed, it will be understood to one with ordinary skill in the art that inlet spools having varied passageway inner diameters than those disclosed herein can be used in the practice of this invention.

With the ratio in size changing at one end of the inlet spool 10 in comparison to the other, the cross-sectional area along the longitudinal axis of the inlet spool also changes. As shown in FIG. 2a, the cross-sectional area of the passageway 62 increases along a length of the passageway from the first end 50 to the second end 52, and in the direction of a predetermined batch flow path A_{F}, and decreases in an opposing path A_{B} generated by back pressure within the melter 12 after shut down.

For example, the first end 50 defines a first cross-sectional area which is less than a second cross-sectional area at the second end 52. As illustrated, the first end 50 defines a first inner diameter D₁ which is less than a second inner diameter D₂ at the second end 52. The passageway 62 within the inlet spool 10 is conical-shaped and is co-axial with a longitudinal central axis A_{L} of the inlet spool, such that the inner diameter of the passageway 62 increases along the longitudinal axis A_{L} of the inlet spool in the direction of the second end 52, or in the direction of the melter 12 in an installed position. In a conical shape, the passageway 62 defines a slope α₁ from the first end 50 to the second end 52. The slope α₁ may be less than 10 degrees, and in some embodiments the slope α₁ may be 5 degrees. In one embodiment, the slope α₁ is 1 degree, with the length of the inlet spool 10 being about 14.75 inches, the first diameter D₁ being about 9.5 inches, and the total diameter D_{S} of the inlet spool 10 being about 10.91 inches.

The inlet spool 10 may also be a multiple piece assembly. For example, the inlet spool 10 may be formed by a pipe secured within a barrel. The pipe may be secured within the barrel by any conventional means, such as for example, the use of positioning plates and hardware. The pipe is positioned within the barrel to define a radial passageway which may be water-cooled to control the temperature within the pipe. The temperature control may be used to supplement the geometric features of the pipe to control the flow of glass in either direction within the pipe.

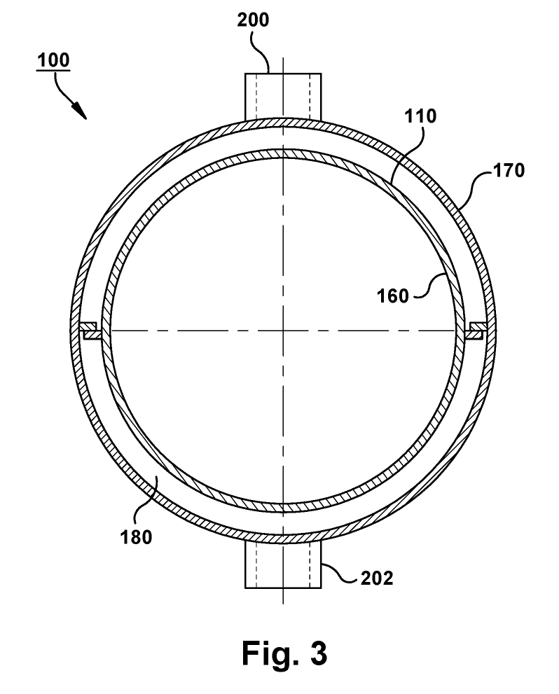

Referring now to FIG. 2b, a sectional view of an inlet spool 100 is shown. The inlet spool 100 includes a pipe 110 positioned within a barrel 170. The pipe 110 and the barrel 170 are each positioned in a co-axial relationship about the longitudinal axis A_{L}. As illustrated in FIG. 2b, the pipe 110 and the barrel 170 are positioned to define a radial passageway 180 or chamber between the pipe and the barrel. This radial passageway 180 is also shown in FIG. 3, the sectional view shown along the line 3-3 of FIG. 2b.

In the exemplary barrel illustrated in FIGS. 2b and 3, the barrel 170 has a first end 172 and a second end 174 in coordination with the pipe 110. On or near the first end 172 and on or near the second end 174 are connectors for use in securing the pipe 110 within the barrel 170. At the first end 172 of the barrel 170, a first flange 176 provides spacing between the pipe and the barrel at the first end. At the second end 174 of the barrel 170, a rear plate 178 provides spacing between the pipe and the barrel at the second end. A second flange 182 is positioned adjacent to or near the second end 174.

The inlet spool 100 is securable and removable from the glass processing line similar to conventional piping equipment. For example, the first flange 176 is connectable to a first glass processing element, such as for example, a glass batch input line, and the second flange 182 is connectable to a second glass processing element, such as for example, a melter input line. However, it should be understood to one with ordinary skill in the art that other installation configurations can be used in the practice of this invention.

As discussed herein, the pipe 110 is positioned within the barrel 170 to define a radial passageway 180 which may be water-cooled to control the temperature within the pipe 110. The passageway 180 is accessible by one or more apertures in the outer wall of the barrel 170. In the exemplary embodiment shown in FIGS. 2b and 3, a coupling is positioned through an external wall of the barrel to provide fluid access to the passageway. For example a top coupling 200 provides access for an inlet water line, and a bottom coupling 202 provides access for an outlet water line. It should be understood to one with ordinary skill in the art that other passageway cooling devices and/or configurations can be used in the practice of this invention.

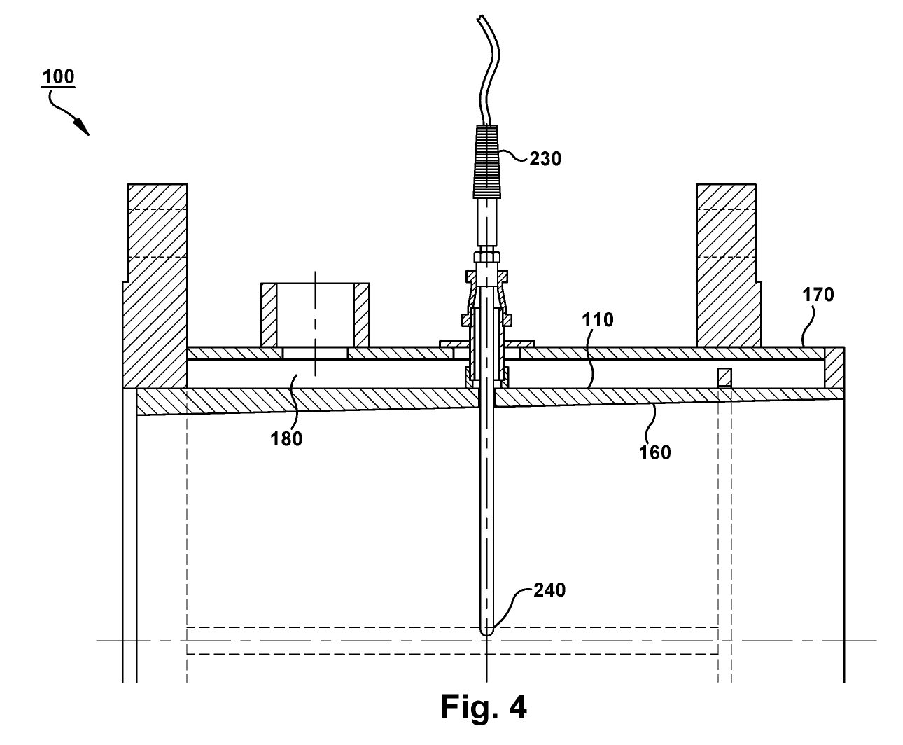

While the temperature of the passageway is being controlled by water, the temperature of the contents of the pipe 110 must be measured. An exemplary inlet spool 100 having temperature measurement capability is shown in FIG. 4. In this figure, the top portion of the inlet spool of FIG. 2b is illustrated with a thermocouple installed. In this position, the end 240 of the thermocouple 230 reaches into the passageway and is positioned for temperature readings of the contents of the pipe 110.

While various inventive aspects, concepts, and features of the general inventive concepts are described and illustrated herein in the context of various exemplary embodiments, these various aspects, concepts, and features may be used in many alternative embodiments, either individually or in various combinations and sub-combinations thereof. Unless expressly excluded herein all such combinations and sub-combinations are intended to be within the scope of the general inventive concepts. Still further, while various alternative embodiments as to the various aspects, concepts, and features of the inventions (such as alternative materials, structures, configurations, methods, circuits, devices and components, software, hardware, control logic, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the general inventive concepts even if such embodiments are not expressly disclosed herein. Additionally, even though some aspects, concepts, and features of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, concepts, and features may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

1. An inlet spool for interfacing with a melter, the inlet spool comprising:
a pipe having a first end, a second end, and an inner wall defining a passageway between the first end and the second end,
wherein a cross-sectional area of the passageway increases along a length of the passageway from the first end of the pipe to the second end of the pipe,
wherein the pipe is operable to convey glass forming material through the passageway from the first end of the pipe to the second end of the pipe to a location in the melter below a level of molten glass in the melter, and
wherein the pipe is operable to prevent the molten glass in the melter from flowing through the passageway to the first end of the pipe, and
wherein the passageway defines a decreasing slope from the first end of the pipe to the second end of the pipe of less than 5 degrees.

2. The inlet spool of claim 1, wherein the passageway is conical-shaped.

3. (canceled)

4. The inlet spool of claim 1, wherein the first end of the pipe has a first inner diameter between 9.00 and 10.00 inches,
wherein the second end of the pipe has a second inner diameter between 9.25 and 10.25 inches, and
wherein the passageway has a length between 12.25 and 17.75 inches.

5. The inlet spool of claim 1, wherein the first end of the pipe has a first inner diameter between 9.25 and 9.75 inches,
wherein the second end of the pipe has a second inner diameter between 9.50 and 10.00 inches, and
wherein the passageway has a length between 14.00 and 16.00 inches.

6-7. (canceled)

8. The inlet spool of claim 1, wherein the first end of the pipe has a first inner diameter and the second end of the pipe has a second inner diameter, and
wherein the first inner diameter is at least 90% of the second inner diameter.

9. The inlet spool of claim 1, wherein the first end of the pipe has a first inner diameter and the second end of the pipe has a second inner diameter, and
wherein the first inner diameter is at least 95% of the second inner diameter.

10-13. (canceled)

14. The inlet spool of claim 1, wherein all parts of the inlet spool are static during the flow of the glass forming material or the molten glass in either direction along a longitudinal axis of the inlet spool.

15. The inlet spool of claim 1, further comprising:
a barrel having a first end and a second end;
a first connector secured to the first end of the barrel, the first connector operable to connect to a batch feeding device; and
a second connector secured to the second end of the barrel, the second connector operable to connect to the melter,
wherein the pipe is secured inside the barrel.

16. The inlet spool of claim 15, wherein the first connector is a first flange.

17. The inlet spool of claim 15, wherein the second connector is a second flange.

18. The inlet spool of claim 15, wherein the pipe and the barrel are positioned to define a radial chamber between the pipe and the barrel.

19. The inlet spool of claim 18, further comprising a coupling,
wherein the coupling is positioned through an external wall of the barrel to provide fluid access to the radial chamber.

20. The inlet spool of claim 18, further comprising a thermocouple,
wherein the thermocouple is positioned for temperature readings of the contents of the passageway.

21. A method of delivering glass forming material to a melter, the method comprising:
connecting a batch feeding device to the melter, wherein the inlet spool of claim 1 is positioned between the batch feeding device and the melter;
delivering the glass forming material from the batch feeding device, through the inlet spool, and to the melter;
removing the batch feeding device from the inlet spool; and
allowing molten glass from the melter to flow into the inlet spool,
wherein the molten glass does not reach a first end of the inlet spool opposite a second end of the inlet spool interfaced with the melter.
